(19) United States
(12) Patent Application Publication
(10) Pub. No.: US 2010/0170373 A1
(43) Pub. Date: Jul. 8, 2010

(54) CUTTING DEVICE

(76) Inventor: Bert-Inge Green, Bromolla (SE)

Correspondence Address: GREER, BURNS & CRAIN, 300 S WACKER DR, 25TH FLOOR, CHICAGO, IL, 60606, US

(21) Appl. No.: 12/601,733

(22) PCT Filed: May 22, 2008
(86) PCT No.: PCT/SE08/50602

§ 371 Date: Dec. 10, 2009

(30) Foreign Application Priority Data
May 25, 2007 (SE) 0701260-2

(51) Int. Cl. B26D 1/00; B26D 5/12

(52) U.S. Cl. 83/13; 83/639.1; 83/623

(57) ABSTRACT

Cutting device (1) for lengthwise cutting of a moving, flexible web (2) containing an initial knife pulley (4), a second knife pulley (6) and a cylinder (11) with a moving piston (13), said second knife pulley being adjustable relative to the first knife pulley subject to the compressive force from the piston to bring the edge of the second knife pulley (10) to work with the edge of the first knife pulley (9). According to the invention, the cutting device has a slide (14) that is situated between the second knife pulley and the cylinder, said slide being adjustable in the axial direction of the second knife pulley and connected to the piston to follow its movement, and in which slide the second knife pulley has been rotatively stored.

This invention relates to a cutting device for lengthwise cutting of a moving web of a flexible material, said cutting device including an initial knife pulley, a second knife pulley and a cylinder which includes a moving piston, said second knife pulley, subject to a compressive force from the piston, is adjustable in an axial direction relative to the first knife pulley to bring the second knife pulley edge to work with the first knife pulley edge.

The invention also relates to a machine for manufacturing or processing a paper web, said machine including a cutting device of the type mentioned above for lengthwise cutting of the paper web.

The invention also relates to a method for using a cutting device to cut a moving web of a flexible material, said cutting device including an initial knife pulley, a second knife pulley which is coordinated with the first knife pulley, and a cylinder containing a moving piston, said method including the stage that a compressive force between the first knife pulley edge and the second knife pulley edge is regulated by the second knife edge, in its axial direction and subject to the force of a compressive force from the piston, being pressed against the first knife pulley.

In this context “a moving web of flexible material” means, for example, a moving paper or paperboard web, textile web or a web of metal or plastic foil.

### BACKGROUND

A cutting device of the type mentioned above is previously known through Reinhold Schable: Slitter Performance: Problems and Solutions, 1990 Finishing and Converting Conference Proceedings. One problem with this type of cutting device is that the sluggishness in the cylinder's piston seal has a braking effect on the rotation of the knife pulley, which is not desirable. Another problem is that the sluggishness of the cylinder's piston seal risks exceeding the desired compressive force between the edges of the knife pulleys. In other words, the desired compressive force risks being less than the force required to overcome the internal friction in the cylinder. This makes it difficult for an operator to set the desired knife pressure and results in the operator unintentionally increasing the pressure in the cylinder to levels that cause knife damage and poor cutting results.

### BRIEF DESCRIPTION OF THE INVENTION

The purpose of this invention is to resolve these problems and produce a cutting device of the type mentioned in the introduction which is simple in design and where the sluggishness in the cylinder's piston seal does not affect the rotation of the knife pulley as well as providing an exact setting of the compressive force between the edges of the knife pulleys. The purpose of the invention is also to produce a method of the type mentioned in the introduction that provides exact and reliable lengthwise cutting of the moving web.

The cutting device, according to the invention, is characterized by that it includes a slide situated between the second knife pulley and the cylinder that is adjustable in the second knife pulley's axial direction and which is connected to the piston to follow its movement, said slide in the second knife pulley is rotatively stored.

The method, according to the invention, is characterized by that the compressive force from the piston is being transferred to the second knife pulley through a slide that is adjustable in the second knife pulley's axial direction and which is connected to the piston to follow its movement, said slide in the second knife pulley is rotatively stored.

### DESCRIPTION OF THE FIGURES

The invention will be described in more detail in the following with reference to the attached drawings, where

FIG. 1 shows a cutting device according to the first embodiment of the invention, and

FIG. 2 shows a cutting device according to the second embodiment of the invention.

### DESCRIPTION OF EMBODIMENTS

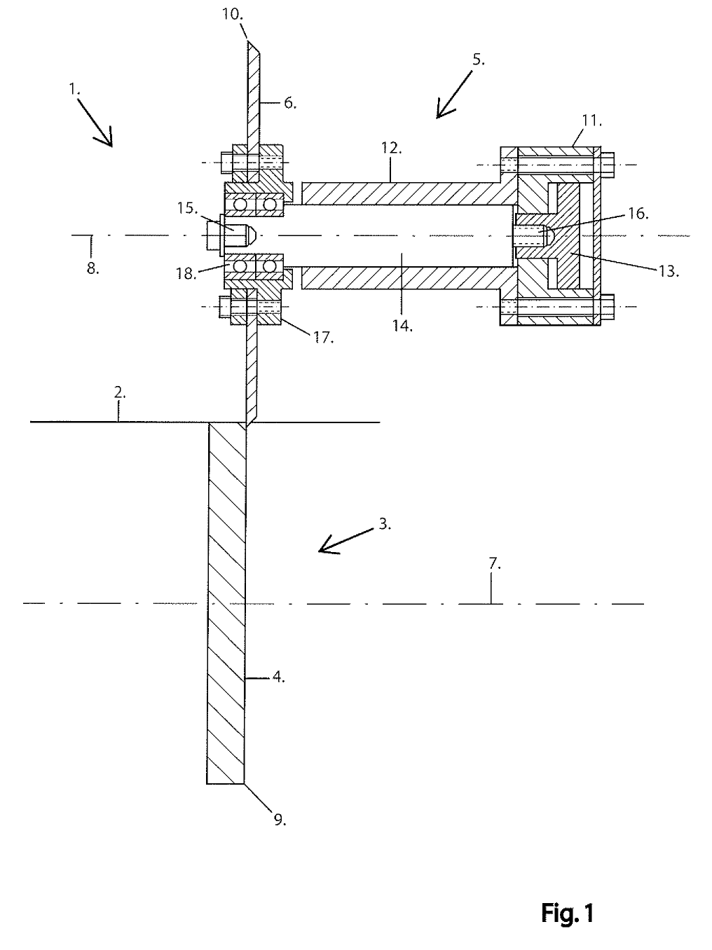

FIG. 1 shows a cutting device (1) for lengthwise cutting of a moving paper web (2) in a machine to manufacture or process paper. Such a machine can, for example, be a paper machine, coiling machine or a converting machine. The cutting device (1) in part includes a bottom knife (3), which includes an initial, lower circular knife pulley (4), in part an upper knife (5) which includes a second, lower circular knife pulley (6). The lower knife (3) is situated beneath the paper web (2) and the upper knife (5) above the same, and the paper web (2) thus runs between the knives (3), (5). The knife pulleys (4), (6) are rotatable on their own rotation axes (7), (8), said rotation axes (7), (8) are parallel and extend in the paper web's (2) crosswise direction. Each knife pulley (4), (6) has an edge in its periphery (9), (10), which goes around the knife pulleys (4), (6) in a circular direction. In the cutting device's (1) cutting position, shown in FIG. 1, the knife pulley (4), (6) edges (9), (10) are situated in such a manner that scissors assist in cutting the paper web (2) lengthwise as it passes between the knife pulleys (4), (6). Thus in the cutting position the edges (9), (10) overlap and are in contact with each other, and the distance between the rotational axes (7), (8) in the cutting position is thus somewhat smaller than the sum of the radii of the knife pulleys (4), (6).

The upper knife (5) can be raised and lowered in a direction that is perpendicular to the paper web (2) relative to the lower knife (3) in order to bring it between a lower and an upper position. When the upper knife (5) is in its lower position, the cutting device (1) assumes the cutting position shown in FIG. 1, and when the upper knife (5) is in its upper position, the cutting device (1) assumes a non-cutting position (not shown) where the paper web (2) is released from the upper knife pulley (6).

The upper knife pulley (6) is adjustable in its axial direction to make it possible to regulate the knife pressure, that is to say the compressive force between the edges (9), (10), when the cutting device (1) is in its cutting position. For this adjustment, the upper knife (5) contains a pneumatic two-way cylinder (11) and a tube-shaped holder (12) that is permanently connected to the cylinder (11). The pneumatic cylinder (11) contains a piston (13), which is adjustable forwards and backwards in the axial direction of the upper knife pulley (6) relative to the holder (12). The upper knife (5) also contains a cylinder-shaped slide (14) that is adjustable inside the holder so that it can run back and forth in the axial direction of the upper knife pulley (6). The slide (14) has a shaft journal (15) at one end and a journal (16) at the other end that is securely connected to the pneumatic cylinder (11) piston (13). The upper knife (5) also contains a knife holder (17) that is situated to be rotatable on the shaft journal (15) using two ball bearings (18), in which knife holder (17) the upper knife pulley (6) is securely mounted.

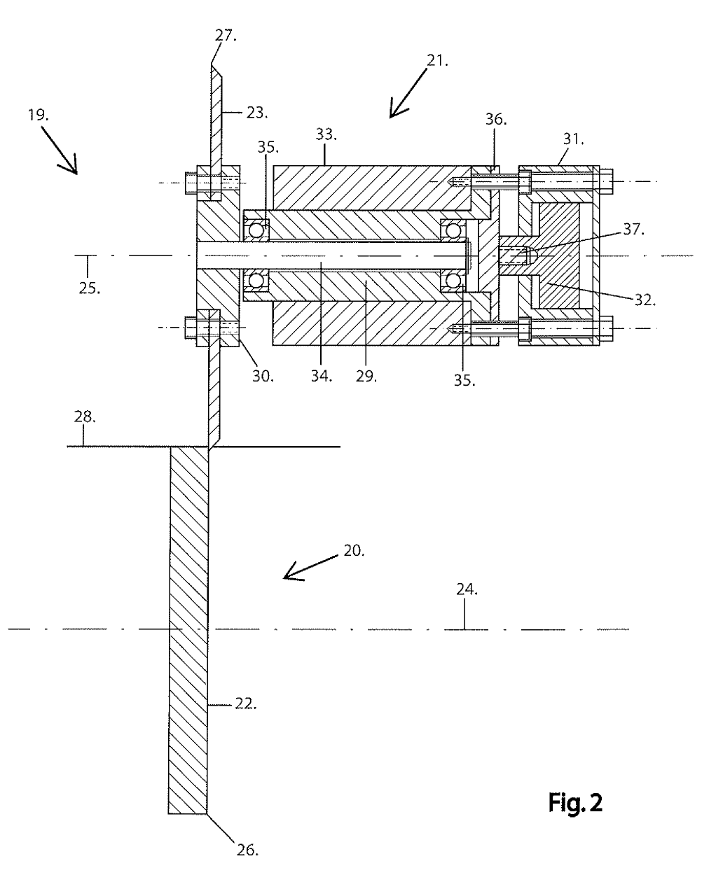

FIG. 2 shows a second embodiment for a cutting device (19) according to the invention. As with the cutting device described above (1), the cutting device (19) includes a lower knife (20) and an upper knife (21) which contain lower and upper circular knife pulleys (22), (23). The knife pulleys (22), (23) are rotatable on each of their rotational axes (24), (25) and have edges (26), (27) that are situated to assist in cutting a paper web (28) in the same manner as described in the cutting device (1). The lower knife (20) has the same design as the lower knife described above (3), and the upper knife (21) is similar to the upper knife described above (5) with the exception of the design of the upper knife (21) slide (29) and knife holder (30) and the knife holder's (30) rotatable coupling in the slide (29) and the slide's (29) coupling to the pneumatic cylinder (31) piston (32).

The slide (29), subject to the effects of the piston (32), is mounted to be adjustable in a container (33) in the same manner as the cutting device (1). The slide (29) in this case has a tube-shaped, axial opening, and the knife holder (30) contains a shaft (34) that extends along an axis through the slide (29) and rotatively rests in the opening on ball bearings (35) at each end of the slide (29). In other words, the knife holder (30) is installed to rotate in the slide's (29) tube-shaped, axial opening, and subject to the force of the piston (32), mounted to be adjustable in the holder (33) together with the slide (29). The slide (29) is securely connected to the piston (32) through an adaptor (36) that is connected to the slide (29) at one end, and has a journal (37) at the other end, that is attached to the piston (32) in the same manner as with the cutting device (1).

As the knife holder (30) contains a shaft (34) that extends through the slide (29), the upper knife (21) movement in a radial direction can be minimized as the ball bearings (35) can be situated at a distance from each other. This provides a stable attachment for the knife holder (30) in the slide (29). This in turn provides a lighter knife holder (29) and fewer ball bearings can be used, which reduces the weight of the part of the cutting device that is adjustable in an axial direction and makes it possible to make a precise setting of the compressive force between the knife pulleys (22) and (23). The ball bearings (35) are also in a protected position inside the axial opening.

The compressive force between the edges (9), (26) of the first knife pulleys (4), (22) and the edges (10), (27) of the second knife pulleys (6), (23) is thus regulated by the second knife pulleys (6), (23), in its axial direction and subject to a compressive force from the pistons (13), (32), being pressed against the first knife pulleys (4), (22). According to the invention the compressive force from the pistons (13), (32) is transferred to the second knife pulleys (6), (23) through the slides (14), (29) that are adjustable in the second knife pulleys (6), (23) axial directions and which is connected to the pistons (13), (32) to follow their movements, in which slides (14), (29) the second knife pulleys (6), (23), via the knife holders (17), (30), are rotatively stored.

According to the invention, the pistons (13), (32) and slides (14), (29) are designed to perform a clean translation movement, that is to say no rotational movement. As the upper knife pulleys (6), (23) are rotatively stored in slides (14), (29) this retains the advantage that the sluggishness of the pneumatic cylinder (11), (31) piston seals does not affect the rotation of the knife pulleys (6), (23). As the piston seals are not required to create a seal against a rotational movement but only against a clean translation movement, this also retains the advantage that an exact setting can be made for the compressive force between the edges of the knife pulleys.

Another advantage is that the cutting device, according to the invention, is a simplified design compared to prior technology, which makes it possible to reduce the size of the cutting device and remove several moveable parts.

As stated above, the holders (11), (31) are securely connected to the bodies of the cylinders (11), (31) and the slides (14), (29) are securely connected to the cylinder (11), (31) pistons (13), (32). These joints should preferably be detachable. The holders (11), (31) and slides (14), (29) could, for example, be connected to the cylinders (11), (31) with detachable screwed joint reinforcements. That will retain the advantage of easing maintenance work on the cutting device and replacing the cylinders (11), (31) or other pieces of the cutting devices.

For the raising and lowering motion described above for the upper knife, the holders (12), (33) are assembled on a stand that can be raised and lowered (not shown).

The preceding described the invention based on two specific embodiments. Other embodiments and variations are possible within the scope of the invention. For example, the cylinder could be a hydraulic cylinder rather than a pneumatic cylinder.

### REFERRAL NUMBERS

| | |
|---|---|
| 1 | Cutting device, first embodiment |
| 2 | Paper web |
| 3 | Lower knife |
| 4 | First, lower knife pulley |
| 5 | Upper knife |
| 6 | Second, upper knife pulley |
| 7 | Rotation shaft (for lower knife) |
| 8 | Rotation shaft (for upper knife) |
| 9 | Edge (for lower knife) |
| 10 | Edge (for upper knife) |
| 11 | Pneumatic cylinder |
| 12 | Holder |
| 13 | Piston |
| 14 | Slide |
| 15 | Shaft journal |
| 16 | Journal |
| 17 | Knife holder |
| 18 | Ball bearing |
| 19 | Cutting device, second embodiment |
| 20 | Lower knife |
| 21 | Upper knife |
| 22 | Lower knife pulley |
| 23 | Upper knife pulley |
| 24 | Rotation shaft |
| 25 | Rotation shaft |
| 26 | Edge |
| 27 | Edge |
| 28 | Paper web |
| 29 | Slide |
| 30 | Knife holder |
| 31 | Pneumatic cylinder |
| 32 | Piston |
| 33 | Holder |
| 34 | Shaft |
| 35 | Ball bearing |
| 36 | Adapter |
| 37 | Journal |

1. A cutting device for lengthwise cutting of a moving web of a flexible material, said cutting device comprising an initial knife pulley, a second knife pulley and a cylinder that includes a moving piston in which the second knife pulley, in its axial direction and subject to a compressive force from the piston, is adjustable relative to the first knife pulley to bring the edge of the second pulley to work with the edge of the first pulley, wherein a slide is situated between the second knife pulley and the cylinder that is adjustable in the second knife pulley's axial direction and which is connected to the piston to follow its movement, and wherein the slide has a tube-shaped, axial opening, and the second knife pulley is mounted in a knife holder that includes a shaft that is rotatively mounted in said opening.

2. A cutting device according to claim 1, wherein the cutting device includes a tube-shaped holder that is securely connected to the cylinder, in which holder the slide is mounted to run only transversally.

3. A cutting device according to claim 1, wherein the shaft is rotatively resting on ball bearings that are mounted in said axial opening at each end of the slide.

4. A cutting device according to claim 1, wherein the slide is mounted to make only a translation movement.

5. A cutting device according to claim 1, wherein the cylinder is a pneumatic cylinder.

6. A machine for lengthwise cutting of a moving web of a flexible material, comprising a cutting device according to claim 1 for lengthwise cutting of paper webs.

7. A machine according to claim 6, adapted for processing a paper web, wherein said cutting device is configured for lengthwise cutting of the paper web.

8. A method for cutting a moving web of a flexible material lengthwise with a cutting device, said cutting device containing an initial knife pulley, a second knife pulley, that is designed to work with the first knife pulley, a cylinder, containing a moving piston connected to the second knife pulley through a slide that is adjustable in the axial direction of the second knife pulley and has a tube-shaped, axial opening, wherein said second knife pulley is mounted in a knife holder that includes a shaft that is rotatively mounted in said opening in the slide, said method comprising, adjusting the compressive force between the edge of the initial knife pulley and the edge of the second knife pulley by transferring the compressive force of the piston through the slide, and advancing the moving web of flexible material lengthwise through the initial and second knife pulleys.
